(19) United States
(12) Patent Application Publication
(10) Pub. No.: US 2008/0075051 A1
(43) Pub. Date: Mar. 27, 2008

(54) METHODS, APPARATUS AND ARTICLES FOR RADIO FREQUENCY PLANNING

(76) Inventors: Baris Dundar, San Pablo, CA (US); Raymond Liao, Pleasanton, CA (US); Onur Kaya, Istanbul (TR)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/624,167

(22) Filed: Jan. 17, 2007

Related U.S. Application Data
(60) Provisional application No. 60/847,851, filed on Sep. 27, 2006.

(51) Int. Cl. H04Q 7/24

(52) U.S. Cl. 370/338

(57) ABSTRACT

Methods, apparatus and articles are presented for use in determining the locations and/or configurations of RF access points. According to a first aspect a method includes receiving, in a processing system, data defining a region of interest, and determining, in the processing system, an access point configuration that provides radio frequency coverage of the region of interest and satisfies minimum desired bandwidth criteria for the region of interest. In some embodiments, the method may include determining an access point configuration using a minimum number of access points. In some embodiments, the method may include (a) determining an access point configuration that provides radio frequency coverage of the region of interest, (b) determining a characterization of the access point configuration, (c) determining a modified access point configuration by at least one change to the access point configuration, (d) determining a characterization of the modified access point configuration, (e) revising the access point configuration if the characterization of the modified access point configuration satisfies a criteria, and (f) repeating (c)-(e) until a termination criteria is satisfied.

### CROSS-REFERENCE TO RELATED APPLICATION

This application claims priority under 35 U.S.C. § 119 to U.S. Provisional Patent Application Ser. No. 60/847,851, entitled “Method and System for Optimally Placing and Configuring Wireless Base Stations for Campus-wide Wireless LAN Deployments”, filed in the name of Dundar et al. on Sep. 27, 2006, the contents of which are hereby incorporated by reference in their entirety for all purposes.

### TECHNICAL FIELD

The present disclosure relates to planning and/or management of wireless communication networks.

### BACKGROUND

Radio frequency (RF) planning is frequently a part of plans to deploy a large-scale wireless LAN (local area network). The purpose of RF planning is to ensure an adequate quality of RF signal coverage across the area in which the wireless LAN is to be deployed. Data to be considered for RF planning includes signal to noise ratio (SNR) and signal to noise plus interference ratio (SINR).

Conventional RF planning efforts generate data that indicates the locations of building features, relevant objects, and planned and/or existing sources of RF signals within a building. However, planning the locations and/or configuration of an RF access point in a region with predefined throughput requirements can be a very complex optimization problem with multiple constraints. For example, due to the presence of obstructions (like walls, ceilings, floors, etc.) inside buildings, the coverage area of an RF access point can contain discontinuities or show dramatic variations.

### SUMMARY

Methods, apparatus and articles presented herein may be used in determining an access point configuration to cover a region of interest. The access point configuration may define a location and/or a configuration of one or more RF access points.

According to a first aspect, a method includes receiving, in a processing system, data defining a region of interest; and determining, in the processing system, an access point configuration that provides radio frequency coverage of the region of interest and satisfies minimum desired bandwidth criteria for the region of interest.

According to a second aspect, an article comprises a storage medium having stored thereon instructions that if executed by a machine, result in the following receiving, in a processing system, data defining a region of interest; and determining, in the processing system, an access point configuration that provides radio frequency coverage of the region of interest and satisfies minimum desired bandwidth criteria for the region of interest.

According to a third aspect of the present invention, an apparatus includes; a processor to receive data defining a region of interest and determine an access point configuration that provides radio frequency coverage of the region of interest and satisfies minimum desired bandwidth criteria for the region of interest.

### BRIEF DESCRIPTION OF THE DRAWINGS

Further aspects of the instant system will be more readily appreciated upon review of the detailed description of the preferred embodiments included below when taken in conjunction with the accompanying drawings, of which:

FIG. 1A is a graphical representation of an optimal location problem;

FIG. 1B is a schematic plan view of a campus in accordance with some embodiments;

FIG. 2 is a flow chart that illustrates a process in accordance with some embodiments;

FIG. 3 is a flow chart that illustrates a process in accordance with some embodiments;

FIG. 4 is a schematic plan view of a region of interest that may include a floor of a building of the campus of FIG. 1B, in accordance with some embodiments;

FIG. 5 is a schematic plan view of a region of interest that may include the floor of FIG. 4 and an access point, in accordance with some embodiments;

FIG. 6 is a schematic plan view of a region of interest that may include the floor of FIG. 4 and a plurality of access points, in accordance with some embodiments;

FIG. 7 is a schematic plan view of a region of interest that may include the floor of FIG. 4 and a plurality of access points, in accordance with some embodiments;

FIG. 8 is a flow chart that illustrates a process in accordance with some embodiments;

FIG. 9 is a schematic plan view of an access point that may cover a location in the region of interest of FIG. 4 and a movement pattern that may be applied in relation to the access point, in accordance with some embodiments;

FIG. 10 is a flow chart that illustrates a process in accordance with some embodiments;

FIG. 11 is a block diagram of a system that including an RF planning system in accordance with some embodiments; and

FIG. 12 is a block diagram of one embodiment of the RF planning system of FIG. 11.

### DETAILED DESCRIPTION

Planning the locations of access points for a wireless network in a region with predefined application throughput requirements may be a very complex optimization problem with multiple constraints. Due to the presence of obstructions (for example, walls, ceilings, floors, etc.) inside buildings, the coverage area of an access point may contain discontinuities or show dramatic variations.

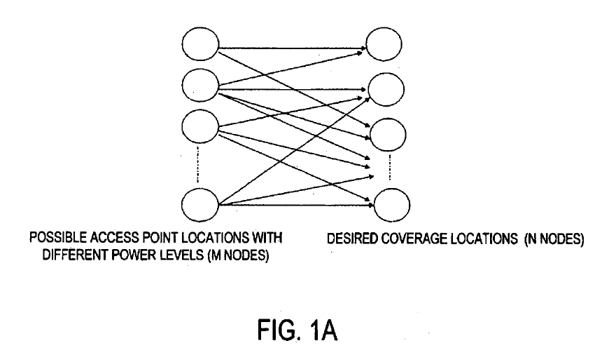

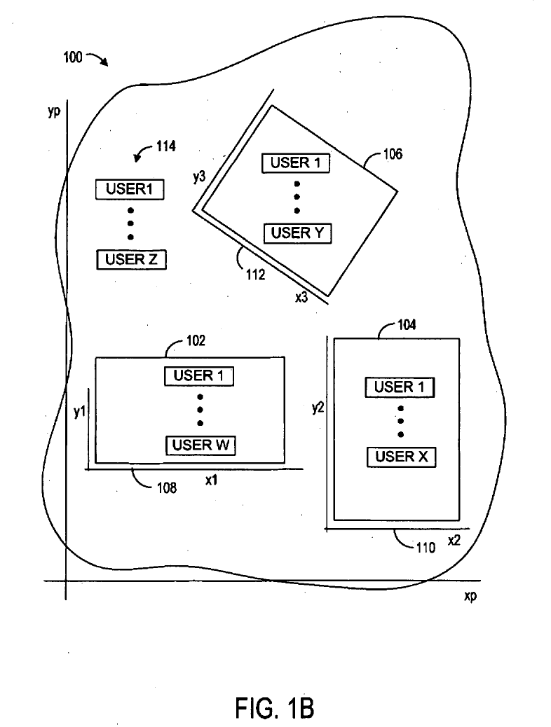

FIG. 1A is a graphical representation of the optimal location problem, in accordance with some embodiments. In the representation of FIG. 1A, the nodes on the left denote the possible access point locations for each power level and the nodes on the right denote the required locations to be covered in a region of interest. If an access point on the left covers the location on the right, then this is denoted by the arrow from the access point to the covered location(s). When a node on the right has multiple arrows pointed to it, interference could be generated at this location if there is more than one access point at the sources of the arrows.

Conventional techniques exist for choosing optimal base station antennas locations and base station configurations. However, these techniques define a number of “watch-points” on the floor and try to meet the coverage requirements of these few watch points, which does not necessarily guarantee 100% RF coverage for the whole floor, building or campus.

This problem, for a two dimensional case, can be formulated as an integer programming model as follows:

Minimize

$${\sum }_{k = 1}^{m} {\sum }_{l = 1}^{n} {Y}_{( k , l )}$$

Subject to the constraints

$${\sum }_{( i , j ) ∈ C ( k , l )} {X}_{( i , j )} = 1 + {Y}_{k , l}$$

for every (k,l), and
X_{(i,j)}ε{0,1} for every (ij)
   where X₍ᵢⱼ₎=1 denotes the presence of an AP at point (ij), Y_{(k,l)} denotes the coverage of the point (k,l) more than once and C(k,l) denotes the set of all the possible AP locations that can cover point (k,l). In reality, calculating the coverage for all possible grid points won't be economical or feasible for most cases.

According to some aspects of the present inventions, in a method and/or apparatus, data defining a region of interest may be received and the method and/or apparatus may determine an access point configuration to cover the region of interest. In some embodiments, the region of interest may comprise a campus and the wireless network may comprise a campus-wide wireless local area network (LAN).

In some embodiments, the location and/or the configuration (e.g., power level) of each access point may be determined using heuristics and dividing the problem into smaller sub-problems and by finding a solution for these smaller regions. In some such embodiments, the regions may be treated separately, which may make the analysis combinatorial, although the size of the analysis may grow exponentially with the size of the region.

In some embodiments, the access point configuration is determined using a focalization process. The focalization process may be iterative and may determine the access point configuration by adding one new access point at a time. In some embodiments, the process may prioritize the uncovered portions of the region of interest, starting with the extreme locations (i.e., corners) furthest from a center of a region of interest in a floor plan. In some embodiments, the process may add access points until 100% coverage is guaranteed.

In some embodiments, the access point configuration may be revised and/or optimized using a search and/or annealing process. Some embodiments of the search and/or annealing process may explore areas of a search space that would be left unexplored by conventional local search procedures. In some embodiments, an optimal location and/or an optimal configuration may be determined for each access point in the access point configuration.

According to some embodiments, the search and/or annealing process may employ fewer function evaluations than are employed by some other processes that may be used in RF planning. Moreover, in some embodiments, the search and/or annealing process may be adapted to escape from local minima. In some embodiments, smart caching techniques may be used to minimize the dependency on the RF propagation calculations.

In some embodiments, the method and/or apparatus may receive location specific throughput requirements and may generate information indicating whether the location specific throughput requirements will be satisfied.

In some embodiments, method and/or apparatus may attempt to minimize the interference in the region of interest while covering all the desired areas in accordance with the location specific throughput requirements and/or other predefined application requirements (if any).

As used herein, an “access point” is a device that transmits and/or receives data. Some access points may connect some users to other users and/or a network. Some access points may connect one network, e.g., a wireless network, to another network, e.g., a wired network.

In some embodiments, an access point may include various components, for example, a base station, antennas, transceivers, amplifiers and/or cables etc. In some embodiments, the components of an access point may be arranged into a single integral unit. In some embodiments, two or more components of an access point may be distributed. If an access point has two or more distributed components, the two or more components may communicate with one another through a communication link.

Also, unless stated otherwise, an access point may include, for example, but is not limited to, hardware, software, firmware, hardwired circuits and/or any combination thereof. In addition, unless stated otherwise, an access point may be any type of access point, for example, programmable or non programmable, general purpose or special purpose, dedicated or non dedicated, shared or not shared, and/or any combination thereof.

In some embodiments, a location of an access point may be defined by the location of one or more components of the access point.

FIG. 1B is a schematic plan view of a campus 100, in accordance with one embodiment. The campus 100 includes buildings indicated by reference numerals 102, 104, 106. (In other examples, the campus may have just two buildings or may have four or more buildings.) The campus may be a campus of corporate buildings, government buildings, medical center buildings, not-for-profit institution buildings, or a college or university campus. Each of the buildings has a respective building coordinate system used for collecting and/or defining RF planning data relevant to the particular building. In particular, building 102 has coordinate system 108, building 104 has coordinate system 110, and building 106 has coordinate system 112. Each building coordinate system includes an origin point and a set of three mutually orthogonal axes that pass through the origin point. The axes may consist of two horizontal axes (“x” and “y”) at right angles to each other and a vertical (height) “z” axis. (In the drawing, the vertical/height “z” axis is not shown). Although the building coordinate systems are shown slightly spaced from their respective buildings for purposes of illustration, in practice the origin point of each building coordinate system may coincide with a corner of the respective building, and each of the horizontal (“x” and “y”) axes may coincide with an outer surface of a wall of the respective building. The building coordinate systems may be selected and/or established in accordance with conventional practices for generating RF planning data within a building.

In addition, in accordance with some embodiments, a campus-wide or “plant” coordinate system 114 may be established. The plant coordinate system 114 includes a plant origin point and a set of three mutually orthogonal axes that pass through the plant origin point, The axes of the plant coordinate system include two horizontal axes “xp” and “yp” at right angles to each other and a vertical (height) “zp” axis which is not shown. In some cases the plant coordinate system may be selected to coincide with one or more of the building coordinate systems.

In some embodiments, one or more locations of the campus 100 may have a known or planned for number of users to be supported. For example, building 102 may have a W number of users, building 104 may have an X number of users, building 106 may have a Y number of users, and so on. In some embodiments, one or more locations outside of buildings (if any) may have a known or planned for number of users to be supported. For example, location 114 of campus is disposed outside the buildings 102, 104, 106 and may have a Z number of users.

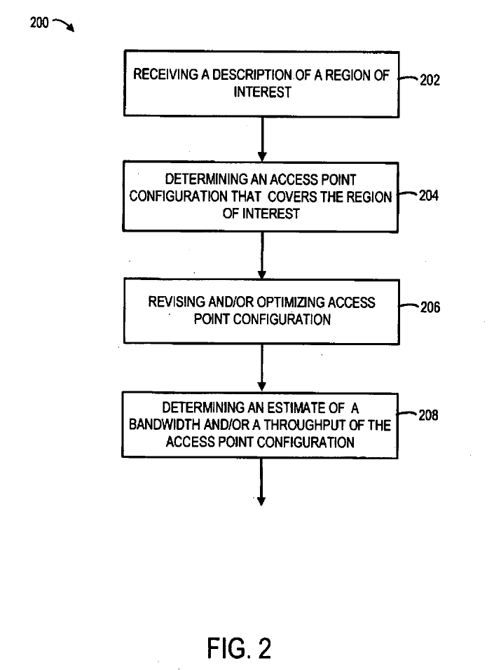

FIG. 2 is a flow chart that illustrates a process in accordance with some embodiments of the present invention. In some embodiments, the process (or portions thereof) may be employed in determining an access point configuration for a network to cover a region of interest, e.g., the campus 100 (FIG. 1B) or a portion thereof.

It should be understood that the process is not limited to the order shown in the flow chart. Rather, embodiments of the process may be performed in any order that is practicable. For that matter, unless stated otherwise, any process disclosed herein may be performed in any order that is practicable. Also, unless stated otherwise, any process disclosed herein may be performed by hardware, software (including microcode), firmware, or any combination thereof Referring to FIG. 2, at 202, the process may include receiving data for RF planning (e.g., for planning the locations and/or types of components of a wireless LAN (local area network)). In some embodiments, such data may include data defining a region of interest.

It should be understood that a region of interest may have any size and/or shape. Further in that regard, a region may or may not be completely continuous. Thus, in some embodiments, a region of interest may have one or more discontinuities. In some embodiments, for example, a region of interest may include all significant portions of a building but may not include one or more of any less or insignificant portions of the building, e.g., a corner of a broom closet. In some embodiments, a region of interest may exclude one or more stairways (if any) of a building.

In some embodiments, the data defining a region of interest may comprise a “blueprint” and/or three-dimensional model of the region of interest (which may include, for example, a floor, building or a campus, and objects in the region of interest, including but not limited to, for example, walks, floors, ceilings, windows, desks, and obstacles, etc.). Such data may include data representing the location and composition of walls and/or any other objects within the region of interest. In some embodiments, the data may include data defining RF attenuation characteristics of one or more objects in the region of interest, which may indicate the degree to which RF signals are likely to be attenuated by passing through the one or more objects. Such objects may have a significant effect on the propagation of RF waves depending on their dimension and type. In some embodiments, the data may include information indicative of neighboring wireless local area networks and/or pre-existing interference sources, if any. In some embodiments, a representation of a blueprint and/or three dimensional model may be displayed on a computer screen.

The data may be in any form, for example, but not limited to, analog and/or digital (e.g., a sequence of binary values, i.e. a bit string) signal(s) in serial and/or in parallel form.

The data may be provided by any suitable source of input data. In some embodiments, the data may include data gathered building-by-building in accordance with conventional practices and on the basis of the individual building coordinate systems for each building. Such data may be received, for example, by direct importation of data from another source or from a data storage medium, or alternatively by the user interacting with a user interface in a conventional manner.

In some embodiments, a source of input data may include one or more systems and/or methods described in one or more of (1) U.S. Patent Application Publication No. 20040177137, entitled “METHODS AND APPARATUS FOR DETERMINING ONE OR MORE ACCESS POINTS IN A COMMUNICATION SYSTEM”, filed on Feb. 28, 2003, (2) U.S. patent application Ser. No. 11/361,913, entitled “RADIO FREQUENCY PLANNING WITH CONSIDERATION OF INTER-BUILDING EFFECTS”, filed on Feb. 23, 2006, (3) U.S. patent application Ser. No. 11/361,911, entitled “METHOD AND APPARATUS FOR AUTOMATED CHARACTERIZATION OF OBJECTS WITH UNKNOWN RF CHARACTERISTICS” filed on Feb. 23, 2006 and/or (4) U.S. patent application Ser. No. 11/361,142, entitled “SIGNAL SOURCE DATA INPUT FOR RADIO FREQUENCY PLANNING” filed on Feb. 23, 2006, the entirety of each of which is incorporated by reference herein. It should be understood, however, that the systems and/or methods disclosed in the present application are not limited to the systems and/or methods disclosed in the applications incorporated by reference herein.

In some embodiments, a source of input data may include a SINEMA system, produced by Siemens AG, of Nuremberg, Germany.

In some embodiments, data defining one or more RF characteristics of an object, e.g., attenuation, may be provided using one or more systems and/or methods described in one or more of the U.S. Patent Application Publication and/or U.S. Patent Applications mentioned above, the entirety of each of which, as stated above, is incorporated by reference herein.

In some embodiments, data defining one or more RF characteristics of an object, e.g., attenuation, may be provided using a system that employs a SINEMA system, produced by Siemens AG, of Nuremberg, Germany.

Notwithstanding the above, it should be understood that data defining the region of interest may be determined and/or supplied by any source or sources. Thus, in some embodiments, data defining the region of interest may be determined and/or supplied by one or more sources external to a processing system that carries out one or more of the processes set forth herein, e.g., determined and/or supplied by a user. In some embodiments data defining the region of interest may be determined and/or supplied by one or more portions of a processing system that carries out one or more of the processes set forth herein. In some embodiments, for example, such processing system may define default data regarding one or more characteristics of a region of interest, which the user may elect to employ or replace, in whole or in part. In some embodiments, data defining the region of interest may be determined and/or supplied by a combination of one or more sources external to the processing system and one or more sources within the processing system. In some embodiments, for example, one or more of the portions of the data defining the region of interest may be defined by the user and one or more portions of the data defining the region of interest may be defined by one or more portions of the processing system. Regardless of the source or sources, one or more portions of the data defining the region of interest may be supplied to and received by one or more portions of the processing system.

At 204, the process may further include determining an access point configuration that covers the region of interest. In some embodiments, the access point configuration may define (1) one or more access points that may be proposed to cover the region of interest and/or (2) a proposed location and/or a proposed configuration (e.g., a frequency and/or a power setting) for each access point in the access point configuration.

As used herein, the phrase “covers” means that all locations within a region of interest are within a range of one or more of the access points in the access point configuration for the wireless network. Unless stated otherwise, the coverage may or may not be uniform within the region of interest. For example, some portions of the region of interest may have better coverage than other portions of the region of interest. Moreover, unless stated otherwise, coverage may or may not meet certain criteria, for example, desired bandwidth and/or throughput. Further, the coverage may include coverage that meets criteria in some portion or portions of the regions of interest without meeting the criteria in some other portion or portions of the region of interest

In some embodiments, the access point configuration is determined using a focalization process, further described hereinafter. The process may be iterative and may determine the access point configuration by adding one new access point at a time. In that regard, the process may prioritize the uncovered portions of the region of interest, starting with the extreme locations.(i.e., corners).furthest from a center of a region of interest in a floor plan. The process may add access points until 100% coverage is guaranteed. In some embodiments, the process (1) adds access points to cover a perimeter of the region of interest, (2) determines whether any portion(s) of the region of interest remains uncovered, (3) adds access points to cover a perimeter of the uncovered portion(s) and (4) repeats (2) and (3) until the entire region of interest is covered.

In some embodiments, the access point configuration determined at 204 may include more access points than what might be considered an optimum number of access points for the region of interest.

At 206, the process may further include revising and/or optimizing the access point configuration determined at 204. In some embodiments, revising and/or optimizing of the access point configuration may be carried out using a search and/or annealing process further described hereinafter. Some embodiments of the search and/or annealing process may explore areas of a search space that would be left unexplored by conventional local search procedures.

In some embodiments, an optimal location and/or an optimal configuration may be determined for each access point in the access point configuration.

In some embodiments, after the locations of the access points and their power levels are determined, a frequency may be assigned to each access point. In some embodiments, the frequencies may be assigned so as to minimize interference between access points.

According to some embodiments, there may be a trade off between maximizing the coverage area and minimizing the interference. Nonetheless, some embodiments, may attempt to choose the optimal locations, power levels and operating frequencies of the access points with the objective of achieving complete coverage with minimum interference in the region of interest using as few access points as possible.

In that regard, some embodiments may guarantee coverage by at least one access point at any given point within the region of interest using the minimum number of access points while minimizing the interference between the neighboring access points. Further in that regard, some embodiments, may determine the optimal locations for the wireless access points and may further determine the optimal frequency and power settings of the wireless access points so as to minimize the interference among neighboring access points.

Some embodiments may receive and take into account information indicative of neighboring wireless local area networks and/or preexisting interference sources, if any.

In some embodiments, a user may define a minimum performance requirement at one or more locations in the region of interest. In some such embodiments, revising and/or optimizing may include adding, moving and/or adjusting the configuration (e.g., parameters, settings, etc.) of one or more access points so as to satisfy (or at least try to satisfy) such minimum performance requirements. In that regard, in some embodiments, the process may include predicting (1) the performance, the coverage and/or the interference at one, some or all locations in the region of interest and/or (2) a change in the performance, the coverage and/or the interference at one, some or all locations in the region of interest, that would result from a change to the location and/or configuration (e.g., power level or frequency) of one or more access points.

In some embodiments, the process may enable the user to change the performance at one or more locations by changing the location and/or configuration of one or more access points. In that regard, in some embodiments, the process may further include dynamically updating the system in case of a change in parameters.

At 208, the process may further include determining an estimate of a bandwidth of one or more access points in the access point configuration. In some embodiments, the estimate of bandwidth may comprise an estimate of a throughput of one or more access points in the access point configuration. In some embodiments, an estimate of the bandwidth and/or an estimate of the throughput may be determined in accordance with one or more methods further described hereinafter.

The estimate of the bandwidth and/or the estimate of the throughput may be compared to one or more reference values. Reference values may be predetermined and/or adaptively determined. Moreover, a reference value may be provided by any source. In some embodiments, the one or more reference values may be provided by a user and/or may represent minimum desired bandwidth criteria for the region of interest.

As used herein, the phrase minimum desired bandwidth criteria for the region of interest means one or more minimum desired bandwidth criteria for one or more locations of the region of interest. In some embodiments, the minimum desired bandwidth criteria may define a minimum desired bandwidth for each location in the region of interest. In some embodiments, for example, all locations in a region of interest may have the same minimum desired bandwidth. That is, the minimum desired bandwidth at one location may be the same as the minimum desired bandwidth at all other locations in the region of interest. In some other embodiments, the minimum desired bandwidth at one or more locations of the region of interest may be different than the minimum desired bandwidth at one or more other locations of the region of interest.

Moreover, as used herein, the phrase minimum desired bandwidth criteria may be any type of bandwidth related criteria. In that regard, in some embodiments, minimum desired bandwidth criteria may comprise one or more minimum desired throughput criteria. Minimum desired bandwidth criteria may relate to any measure(s) and/or estimate(s) of bandwidth. Minimum desired throughput criteria may relate to any measure(s) and/or estimate(s) of throughput. In some embodiments, minimum desired throughput criteria may comprise minimum desired application layer throughput criteria In some embodiments, the minimum desired bandwidth criteria may comprise a minimum desired throughput for one or more access points in the access point configuration.

Minimum desired bandwidth criteria may be determined and/or supplied by any source or sources. Thus, in some embodiments, minimum desired bandwidth criteria may be determined and/or supplied by one or more sources external to the processing system, e.g., by a user. In some embodiments minimum desired bandwidth criteria may be determined and/or supplied by one or more portions of the processing system. In some embodiments, for example, the processing system may define default minimum desired bandwidth criteria, which the user may elect to employ or replace, in whole or in part. In some embodiments, minimum desired bandwidth criteria may be determined and/or supplied by a combination of one or more sources external to the processing system and one or more sources within the processing system. In some embodiments, for example, one or more of the minimum desired bandwidth criteria may be defined by the user and one or more of the minimum desired bandwidth criteria may be defined by one or more portions of the processing system. Regardless of the source or sources, one or more portions of the data defining the region of interest may be supplied to and received by one or more portions of the processing system.

The minimum desired bandwidth criteria may be in any form, for example, but not limited to, analog and/or digital (e.g., a sequence of binary values, i.e. a bit string) signal(s) in serial and/or in parallel form.

The estimate of bandwidth and/or the estimate of throughput may be determined before, during and/or after revising and/or optimizing the access point configuration at 206. In some embodiments, the estimate of the bandwidth and/or the estimate of the throughput may be determined before and/or during revising and/or optimizing at 206, and the estimate of the bandwidth and/or the estimate of the throughput may be taken into consideration during the revising and/or optimizing at 206. For example, if the estimate of the bandwidth and/or the estimate of the throughput is less than a minimum desired bandwidth and/or minimum desired throughput, respectively, the revising and/or optimizing at 206 may include adding one or more access points, moving one or more access points and/or changing the configuration of one or more access points so as to satisfy (or at least try to satisfy) the minimum desired bandwidth and/or minimum desired throughput, respectively.

After an access point configuration is determined, information regarding the access point configuration and/or the entire distributed system may be provided. In some embodiments, providing information may include displaying information on a monitor, generating a report or file that includes the information, storing the information in a database, transmitting the information to another party or device, providing a graphic display of the configured system, etc.

In some embodiments, the method and/or apparatus may allow a user to see the performance of the system and/or effects of changing the locations or parameters on the performance, so that the user can refine and tune the system and its performance according to the user's needs before actually deploying the system.

In some embodiments, the information may be used for real-time management of a wireless LAN or other wireless communication system that extends across a region of interest, e.g., from building to building within a campus.

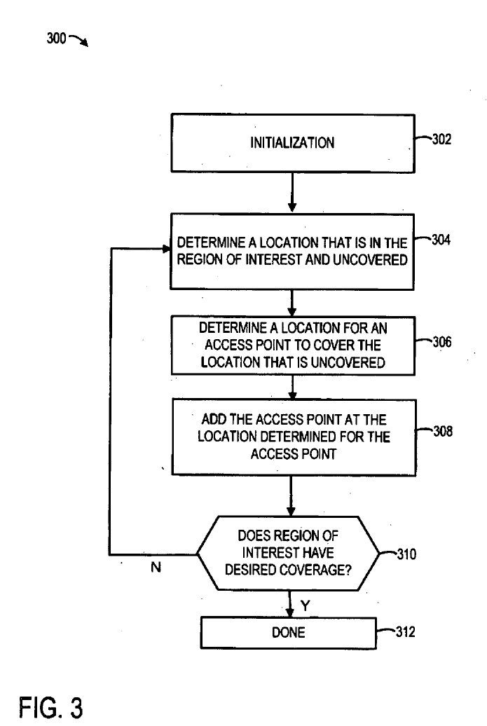

FIG. 3 is a flow chart that illustrates a process for determining an access point configuration, in accordance with some embodiments. In some embodiments, one or more portions of the process illustrated in FIG. 3 may be employed in determining an access point configuration in the process of FIG. 2.

Referring to FIG. 3, at 302, in some embodiments, the process may include initializing an access point configuration. In some embodiments, for example, the access point configuration may initially be initialized so as to include zero access points.

At 304, the process may further include determining a location (within the region of interest) that is to be covered by the wireless network but is not yet covered by an access point defined by the access point configuration. Initially, there may be a plurality of locations that are to be covered by the wireless network but are not yet covered by an access point defined by the access point configuration. For example, if the access point configuration is initialized to include zero access points, then initially, no location in the region of interest is covered by an access point defined by the access point configuration. In some such embodiments, the process may include selecting (i) a location of such plurality of locations that is furthest from a center (if any exist) of the region of interest and/or (ii) a location that is disposed at a corner (if any exist) of the region of interest.

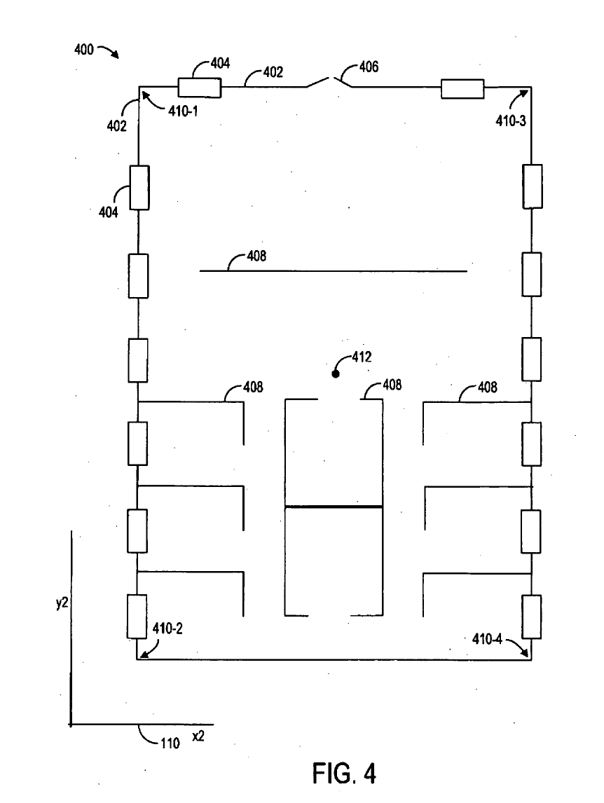

For example, FIG. 4 is a schematic plan view of a region of interest to be covered by a wireless network, in accordance with some embodiments. Referring to FIG. 4, in some embodiments, a region of interest may include a floor 400 of a building, e.g., building 104 (FIG. 1B). The floor 400 may include external walls 402, windows 404, a door 406 and internal walls 408. The external walls 402 may define corners 410-1 to 4104. The region of interest may have a center 412.

The region of interest may include a plurality of locations that are to be covered by the wireless network but are not yet covered by an access point defined by the access point configuration. For example, as stated above, if the access point configuration is initialized to include zero access points, then initially, no location of the region of interest is covered by an access point defined by the access point configuration. In some embodiments, the process may select (i) a location that is furthest from the center 412 of the region of interest and/or (ii) a location that is disposed at one of the corners 410-1 to 410-4 of the region of interest, e.g., the location disposed at the corner 410-1.

Referring again to FIG. 3, at 306, the process may further include determining a location to position an access point such that the access point covers the location determined at 304. In some embodiments, any of a plurality of locations may be suitable to cover the location determined at 304. In some such embodiments, the process may select a location of such plurality of locations that is closest to the center 412 of the region of interest.

For practical reasons, some embodiments may use a uniform grid within the region of interest as candidate locations for access points. The grid size can be adjusted depending on the accuracy/run-time speed requirements. Some embodiments may seek to iteratively place access points until all the grid points are covered while minimizing the overlaps between base stations.

Referring again to FIG. 3, at 308, the process may further include adding an access point to the access point configuration. The access point may be positioned at the location determined at 306.

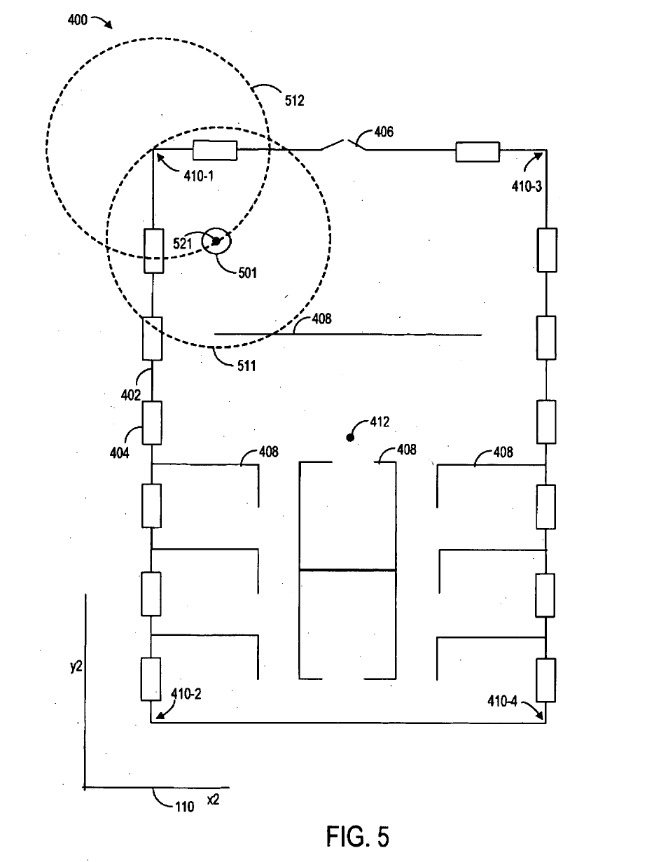

For example, FIG. 5 is a schematic plan view of a region of interest that includes the floor 400 and an access point that is positioned to cover a location in the region of interest, in accordance with some embodiments. Referring to FIG. 5, in some embodiments, an access point 501 may be positioned to cover a location in the region of interest, e.g., the location disposed at corner 410-1. The access point 501 may have a range with an outer perimeter represented schematically by a dashed line 511. The outer perimeter may have the size and shape of the dashed line 511 and/or any other size and/or shape (regular or irregular).

In view of the range of the access point 501, the access point 501 may cover the location disposed at corner 410-1 from any of a plurality of locations. The plurality of locations may define a volume having an outer perimeter represented schematically by a dashed line 512. The outer perimeter may have the size and shape of the dashed line 512 and/or any other size and/or shape (regular or irregular).

In some embodiments, the process may select the location from such plurality of locations that is closest to the center 412 of the region of interest. In some embodiments, for example, the process may select a location 521.

Referring again to FIG. 3, at 310, the process may further include determining whether the access point configuration provides a desired coverage for the region of interest. In some embodiments, the determination may include determining whether the region of interest is completely covered, e.g., whether each location in the region of interest is covered by one or more access points in the access point configuration. If the access point configuration provides the desired coverage, then the process may be complete and may proceed to 312.

If the access point configuration does not provide the desired coverage, the process may further include returning to 304 and/or repeating 304-310 until the access point configuration provides the desired coverage for the region of interest.

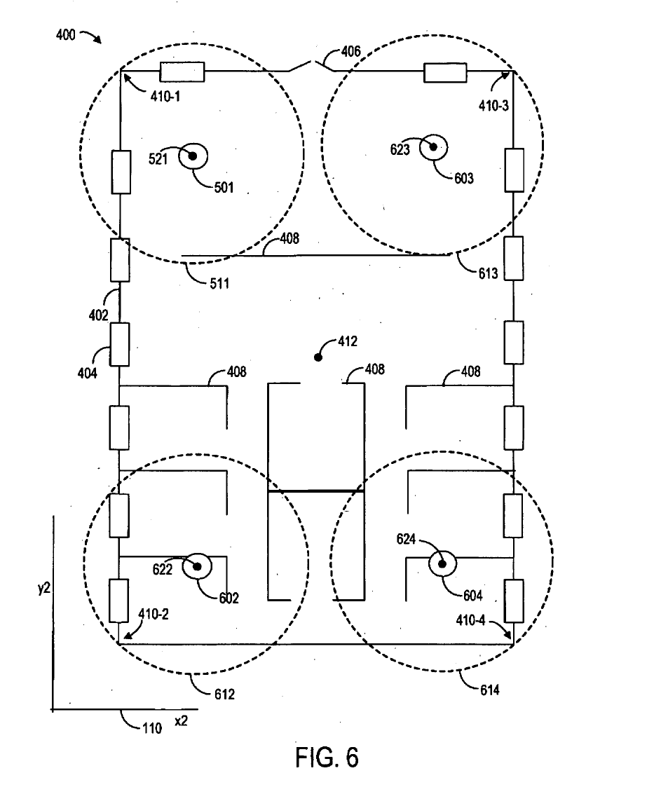

For example, FIG. 6 is a schematic plan view of a region of interest that includes the floor 400 and a plurality of access points positioned to cover locations in the region of interest, in accordance with some embodiments. Referring to FIG. 6, in some embodiments, a plurality of access points, e.g., access points 591 and access points 602-604, may be positioned to cover locations in the region of interest. In some such embodiments, access points 501 may be positioned as described hereinabove with respect to FIG. 5. One or more of the other access points, e.g., access points 602604, may be positioned to cover other locations in the region of interest, e.g., locations disposed at corners 410-2 to 410-4, respectively.

In some embodiments, the access points 602-604 may each have a range with an outer perimeter, represented schematically by dashed line 612-614, respectively. The outer perimeter of the ranges may or may not be the same as one another and may have the size and shape of the dashed lines 612-614, respectively, and/or any other size and/or shape (regular or irregular).

In view of the range of the access points 602-604, the access points 602-604 may cover the locations disposed at corners 410-2 to 410-4, respectively, from any of a plurality of locations. In some embodiments, the process may select locations that are closest to the center 412 of the region of interest. In some such embodiments, for example, the process may select locations 622-624 for the access points 602-604, respectively.

Although FIG. 5 and FIG. 6 do not show complete coverage of the region of interest, in some embodiments, complete coverage may be desired for the region of interest. In some embodiments, the range of one or more of the access points may be adjusted such that complete coverage may be provided for the region of interest. In some other embodiments, one or more additional access points may be employed to help provide complete coverage for the region of interest.

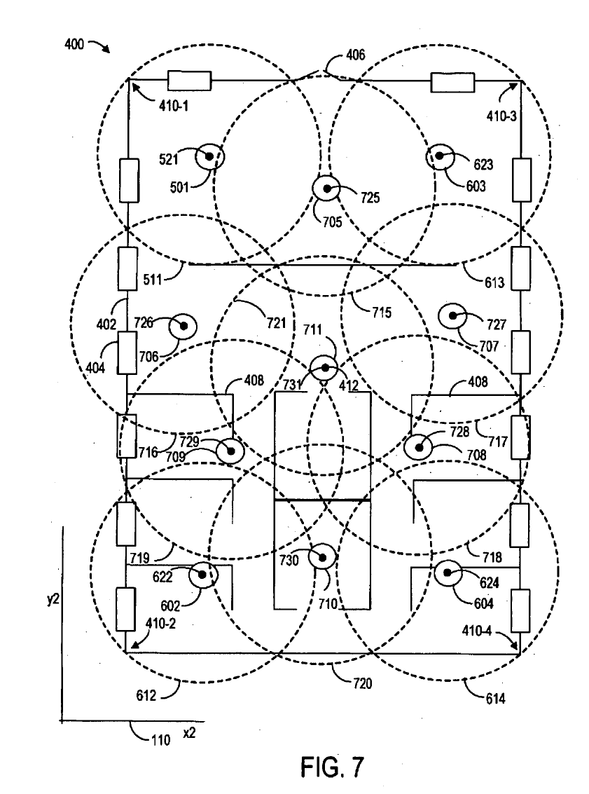

For example, FIG. 7 is a schematic plan view of a region of interest that includes the floor 400 and a plurality of access points that provide complete coverage of the floor 400, in accordance with some embodiments. Referring to FIG. 7, in some embodiments, a plurality of access points, e.g., access points 501, 602-604 and 705-711, may provide complete coverage of the region of interest. One or more of the access points, e.g., access points 501 and 602-604, may be positioned as described above with respect to FIG. 5 and FIG. 6. One or more of the other access points, e.g., access points 705-711, may be positioned to cover other locations in the region of interest.

In some embodiments, the access points 705-711 may each have a range with an outer perimeter, represented schematically by dashed line 715-721, respectively. The outer perimeter of the ranges may or may not be the same as one another and may have the size and shape of the dashed lines 715-721, respectively, and/or any other size and/or shape (regular or irregular).

In view of the range of the access points 705-711, the access points 705-711 may be positioned in any of a plurality of locations. In some embodiments, the process may select locations that are closest to the center 412 of the region of interest. In some such embodiments, for example, the process may select locations 725-731 for the access points 705-711, respectively.

In some embodiments the access points may be added to the access point configuration in the following order (1) access point 501, (2) access point 602, (3) access point 603, (4) access point 604, (5) access point 705, (6) access point 706, (7) access point 707, (8) access point 708, (9) access point 709, (10) access point 710, (11) access point 711. In some other embodiments, a different order, a different number of access points and/or different positioning of access points may be employed.

As stated above, in some embodiments, an access point configuration may include more access points than what might be considered an optimum number of access points for the region of interest.

In that regard, in some embodiments, there may be a desire to revise and/or optimize the access point configuration.

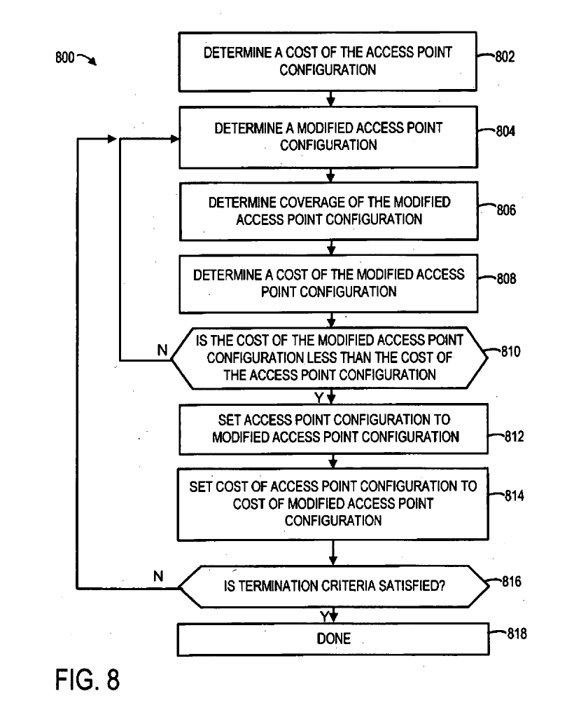

FIG. 8 is a flow chart that illustrates a process for revising and/or optimizing the access point configuration, in accordance with some embodiments. In some embodiments, one or more portions of the process illustrated in FIG. 8 may be employed in revising and/or optimizing the access point configuration in the process set forth in FIG. 2.

Referring to FIG. 8, at 802, in some embodiments, the process may include determining a characterization of the access point configuration. In some such embodiments, the characterization may comprise a cost function, which in some embodiments may be based at least in part on (i) the number of access points, (ii) the input power requirements of the access points, (iii) the number of different frequencies used by the access points, (iv) the power level of the access points, (v) the quality of coverage provided by each access point and/or (vi) the proportion of the region of interest that is covered by more than one access point.

At 804, the process may further include determining a modified access point configuration. In some embodiments, the modified access point configuration may be determined by making one or more changes to the access point configuration. In some such embodiments, the one or more changes to the access point configuration may include (i) moving one or more existing access points, (ii) changing the power level of one or more existing access points, (iii) changing a frequency of one or more existing access points, (iv) deleting one or more existing access points and/or (v) adding one or more new access points.

In some embodiments, the one or more changes to be made may be determined by randomly selecting one or more changes from the list of one or more changes described above. In some other embodiments, the one or more changes may be determined in accordance with a predefined sequence.

In some embodiments, moving an existing access point may include moving the access point in accordance with a one, two, or three dimensional movement pattern. In some embodiments, a movement pattern may be a predefined movement pattern or a dynamically defined movement pattern.

At 806, the process may further include determining a coverage of the modified access point configuration. In some embodiments, one or more aspects of the coverage provided by an access point configuration may be determined using one or more systems and/or methods described in one or more of (1) U.S. Patent Application Publication No. 20040177137, entitled “METHODS AND APPARATUS FOR DETER MING ONE OR MORE ACCESS POINTS IN A COMMUNICATION SYSTEM”, filed on Feb. 28, 2003, (2) U.S. patent application Ser. No. 11/361,913, entitled “RADIO FREQUENCY PLANNING WITH CONSIDERATION OF INTER-BUILDING EFFECTS”, filed on Feb. 23, 2006, (3) U.S. patent application Ser. No. 11/361,911, entitled “METHOD AND APPARATUS FOR AUTOMATED CHARACTERIZATION OF OBJECTS WITH UNKNOWN RF CHARACTERISTICS” filed on Feb. 23, 2006 and/or (4) U.S. patent application Ser. No. 11/361,142, entitled “SIGNAL SOURCE DATA INPUT FOR RADIO FREQUENCY PLANNING” filed on Feb. 23, 2006, the entirety of each of which is incorporated by reference herein. It should be understood, however, that the systems and/or methods disclosed in the present application are not limited to the systems and/or methods disclosed in the applications incorporated by reference herein.

In some embodiments, one or more aspects of the coverage provided by an access point configuration may be determined using a system that employs a SINEMA system, produced by Siemens AG, of Nuremberg, Germany.

At 808, the process may further include determining a characterization of the modified access point configuration. In some embodiments, the characterization comprises a cost function, which in some embodiments may be based at least in part on (i) the number of access points, (ii) the input power requirements of the access points, (iii) the number of different frequencies used by the access points, (iv) the power level of the access points, (v) the quality of coverage provided by each access point and/or (vi) the proportion of the region of interest that is covered by more than one access point.

At 810, the process may further include determining whether the characterization of the modified access point configuration satisfies a criteria indicating that the modified access point configuration may be better than the access point configuration in one or more respects. To that effect, if a cost function is employed, the process may determine whether the cost function of the modified access point configuration is less than the cost function of the access point configuration. If the cost function of the modified access point configuration is not less than the cost function of the access point configuration, the process may return to 804 and may determine another modified access point configuration. In some embodiments, such modified access point configuration may be determined by making one or more changes to the access point configuration that are different, at least in part, than the one or more changes previously made to the access point configuration.

In some embodiments, the process described for 804-810 may be repeated until the process determines a modified access point configuration has a cost function that is less than the cost function of the access point configuration and/or until one or more of the termination criteria is finally satisfied.

In some embodiments, a modified access configuration with a cost function that is higher than the cost function of the access point configuration may indicate a local minima. In some such embodiments, repeating 804-810 with differing combinations of the one or more changes set forth above may enable the process to escape from such local minima.

In some embodiments, the one or more changes to be made in any given iteration is/are determined by randomly selecting one or more changes from the list of changes described above with respect to 804. In some other embodiments, the one or more changes to be made in any given iteration may be determined in accordance with a predetermined sequence.

In some embodiments, the process may limit the number of times that 804-810 may be repeated. In some such embodiments, the process may limit the number of iterations to a predefined number of iterations. If none of the modified access point configurations determined in such predefined number of iterations has a cost function that is less than the cost function of the access point configuration, the process may stop. In some embodiments, the predefined number of iterations may be defined by a user, however, increasing the predefined number of iterations may lead to a longer execution time. In some embodiments, a short-tern memory may be used to store recent (e.g., less than n moves ago) access point configurations.

If the cost function of the modified access point configuration is less than the cost function of the access point configuration, then at 812, the access point configuration may be revised. In that regard, in some embodiments, the access point configuration may be set to the modified access point configuration. At 814, the cost function of the access point configuration may also be revised. In that regard, in some embodiments, the cost function of the access point configuration may be set to the cost function of the modified access point configuration.

At 816, the process may further include determining whether one or more of the termination criteria is satisfied. In some embodiments, the one or more termination criteria may include (i) a desired coverage is achieved, (ii) it is determined that a desired coverage cannot be satisfied (iii) the number of access points reaches a maximum number of access points and/or (iv) a modified access point configuration is worse than N previous best solutions (where N may be a predefined number).

If one or more of the termination criteria is satisfied, the process may be complete and may proceed to 818. If one or more of the termination criteria is not satisfied, the process may return to 804 and the process described hereinabove may be repeated until one or more of the termination criteria is finally satisfied.

In some embodiments, the one or more changes to be made in any given iteration is/are determined by randomly selecting one or more changes from the list of changes described above with respect to 804. In some other embodiments, the one or more changes to be made in any given iteration may be determined in accordance with a predetermined sequence.

In some embodiments, the process set forth in FIG. 8 may include determining hundreds, thousands, tens of thousands, hundreds of thousands or more modified access point configurations.

As stated above, in some embodiments, moving an existing access point may include moving the access point in accordance with a one, two, or three dimensional movement pattern.

In some embodiments, a three dimensional movement pattern may include one or more movements in a positive x direction, one or more movements in a negative x direction, one or more movements in a positive y direction, one or more movements in a negative y direction, one or more movements in a positive z direction and one or more movements in a negative z direction.

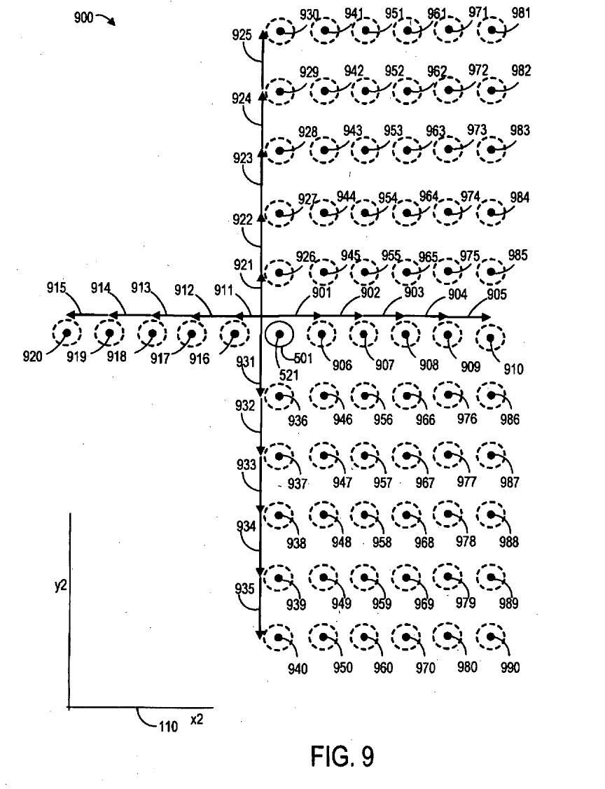

For example, FIG. 9 is a schematic plan view of an access point and a three dimensional movement pattern that may be applied in relation to such access point, in accordance with some embodiments. Referring to FIG. 9, as stated above, the access point 501 may initially be positioned at the location 521. In some embodiments, a three dimensional movement pattern may be applied in relation to the access point 501. The three dimensional movement pattern may include five increment movements 901-905 in a positive x direction, five increments movements 911-915 in a negative x direction, five increment movements 921-925 in a positive y direction, five increment movements 931 -935 in a negative y direction, five increment movements in a positive z direction (not shown) and five increment movements in a negative z direction (not shown).

The five incremental movements 901-905 in the positive x direction may be used to change the position of the access point 501 to locations 906-911, respectively. That is, incremental movement 901 may move the access point 501 from location 521 to location 906. The incremental movement 902 may move the access point 501 from location 906 to location 907. The incremental movement 903 may move the access point 501 from location 907 to location 908. The incremental movement 904 may move the access point 501 from location 908 to location 909. The incremental movement 905 may move the access point 501 from location 909 to location 910.

Similarly, the five incremental movements 911-915 in the negative x direction may be used to change the position of the access point 501 to locations 916-920, respectively. The five incremental movements 921-925 in the positive y direction may be used to change the position of the access point 501 to locations 926-930, respectively. The five incremental movements 931-935 in the negative y direction may be used to change the position of the access point 501 to locations 936-940, respectively.

In some embodiments, a movement pattern may include combinations of the above increment movements, e.g., so as to position the access point 501 at locations 941-990. In some embodiments, a movement pattern may include all combinations of the above incremental movements so as to be capable of positioning the access point 501 at six hundred different locations.

In some embodiments, a movement pattern may include ten increment movements in each direction. In some such embodiments, the movement pattern may include one, some or all combinations of such increment movements.

In some embodiments, a movement pattern may be symmetrical or non symmetrical and may include increment movements that are all the same size or not all the same size.

In some embodiments, determining a modified access point configuration may include moving, and/or changing a power level, of one access point at a time.

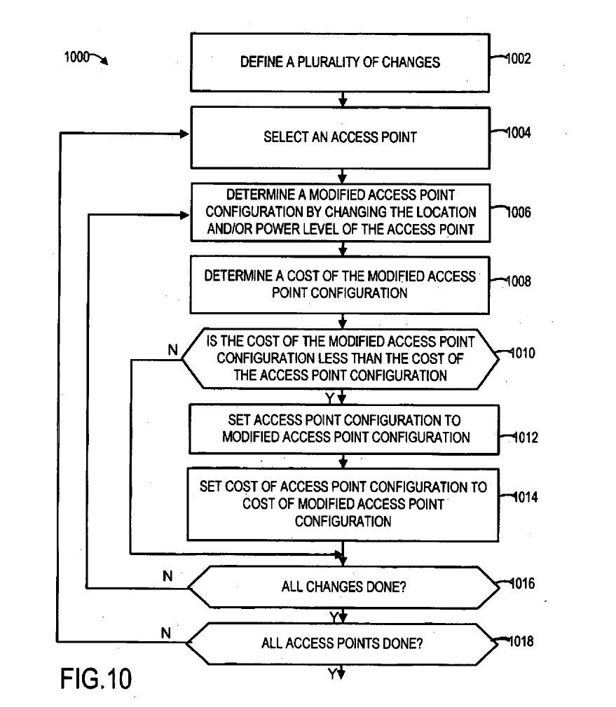

FIG. 10 is a flow chart that illustrates a process for revising and/or optimizing the access point configuration, in accordance with some embodiments. In some embodiments, one or more portions of the process illustrated in FIG. 10 may be employed in revising and/or optimizing the access point configuration in the process set forth in FIG. 2. Referring to FIG. 10, in some embodiments, determining a modified access point configuration may include moving, and/or changing a power level, of one access point at a time.

Referring to FIG. 10, at 1002, in some embodiments, the process may include defining a plurality of changes to be implemented in relation to each access points in the access point configuration. In some embodiments, the changes may include moving an existing access point in accordance with a one, two, or three dimensional movement pattern.

At 1004, the process may further include selecting one of the access points in the access point configuration.

At 1006, the process may further include determining a modified access point configuration by moving and/or changing the power level of the selected access point in accordance with a first of the plurality of changes defined at 1002.

At 1008, the process may further include determining a cost function of the modified access point configuration. In some embodiments, the cost function may be based at least in part on (i) the number of access points, (ii) the input power requirements of the access points, (iii) the number of different frequencies used by the access points, (iv) the power level of the access points, (v) the quality of coverage provided by each access point and/or (vi) the proportion of the region of interest that is covered by more than one access point.

At 1010, the process may further include determining whether the cost function of the modified access point configuration is less than the cost function of the access point configuration. If the cost function of the modified access point configuration is not less than the cost function of the access point configuration, then at 1016, the process may determine whether all of the changes defined at 1002 have been applied in relation to the access point selected at 1004.

If all the changes have not been applied, the process may return to 1006 and may determine a second modified access point configuration. In some embodiments, the second modified access point configuration may be determined by moving and/or changing the power level of the selected access point in accordance with a second of the plurality of changes defined at 1002.

If the cost function of the modified access point configuration is less than the cost function of the access point configuration, then at 1012, the access point configuration may be set to the modified access point configuration. At 1014, the cost function of the access point configuration may be set to the cost function of the modified access point configuration.

As stated above, at 1016, the process may determine whether all of the changes defined at 1002 have been applied in relation to the access point selected at 1004. If all the changes have not been applied, the process may return to 1006 and may determine a second modified access point configuration. In some embodiments, the second modified access point configuration may be determined by moving and/or changing the power level of the selected access point in accordance with a second of the plurality of changes defined at 1002.

In some embodiments, 1006-1016 may be repeated until all of the changes defined at 1002 have been applied in relation to the first access point selected at 1004. In that regard, in some embodiments, a third modified access point configuration may be determined by moving and/or changing the power level of the selected access point in accordance with a third of the plurality of changes defined at 1002. A fourth modified access point configuration may be determined by moving and/or changing the power level of the selected access point in accordance with a fourth of the plurality of changes defined at 1002. And so on.

If, at 1016, all the changes defined at 1002 have been applied in relation to the first access point selected at 1004, then at 1018, the process may determine whether all of the changes defined at 1002 have been applied in relation to all the access points in the access point configuration.

If all of the changes defined at 1002 have not been applied in relation to all the access points in the access point configuration, the process may return to 1004 and may select another access point, e.g., a second access point, from the access point configuration.

Thereafter, at 1006, the process may determine a modified access point configuration by moving and/or changing the power level of the second access point in accordance with a first of the plurality of changes defined at 1002.

At 1008, the process may determine a cost function of the modified access point configuration, and at 1010, the process may determine whether the cost function of the modified access point configuration is less than the cost function of the access point configuration. If the cost function of the modified access point configuration is not less than the cost function of the access point configuration, then at 1016, the process may determine whether all of the changes defined at 1002 have been applied in relation to the access point selected at 1004. If all the changes have not been applied, the process may return to 1006 and may determine a modified access point configuration by moving and/or changing the power level of the second access point in accordance with the second of the plurality of changes defined at 1002.

If the cost function of the modified access point configuration is less than the cost function of the access point configuration, then at 1012, the access point configuration may be set to the modified access point configuration. At 1014, the cost function of the access point configuration may be set to the cost function of the modified access point configuration.

In some embodiments, 1004-1018 may be repeated until all of the changes defined at 1002 have been applied in relation to all the access points in the access point configuration. In that regard, in some embodiments, the process may include determining hundreds, thousands, tens of thousands, hundreds of thousands or more modified access point configurations.

In some embodiments, the location of an access point may be moved such that the access point may be disposed outside the region of interest. In some embodiments, the access point may be deleted if the other access points in the access point configuration cover the region of interest.

In accordance with some aspects of the present inventions, it may be desirable to determine an estimate of the throughput of a network or a portion thereof. In some embodiments, for example, an estimate of the throughput may be used to provide a user with an estimate of the expected application-level network performance. In some embodiments, there may be a requirement to guarantee that an access point configuration provides at least a certain throughput (sometimes referred to herein as minimum application throughput) for a certain region of a region of interest.

Throughput may be affected by the amount of noise and/or interference in a system. In some embodiments, the amount of noise and/or interference in a system may be modeled as the Signal to Interference and Noise Ratio (SINR) or a subset metric called Signal-to-Noise Ratio (SNR).

In some embodiments, throughput may also be affected by a Medium Access Control (MAC) layer random access delay and co-channel interference, which is not modeled by SINR or SNR. In some embodiments, it may be sufficient to use the SINR to derive the coverage quality and data rate while ignoring the effect of MAC layer delay.

In some other embodiments, however, it may be desirable to take the MAC layer delay effect into consideration when estimating the throughput. In accordance with some embodiments, two methods (sometimes referred to as Method A and Method B, respectively) are described herein to take the MAC layer delay effect into consideration when estimating the application throughput.

As further described hereinafter, in some embodiments, each of such methods may start by calculating an effect of MAC layer delay on the application throughput in terms of percentage of reduction on throughput. In accordance with some embodiments, a first method (sometimes referred to herein as Method A) may derive an “equivalent SINR” by assuming the reduction on data rate is a result of increases in the amount of noise. A look-up table may be used to determine an equivalent noise level that will give the same data rate. With this equivalent SiNr, existing methods may be used to calculate, optimize and/or present coverage quality while considering application throughput. In some embodiments, one or more of the methods described herein for RF planning and/or for determining an access point configuration may take application throughput requirements (if any) into account. In that regard, in some embodiments, one or more of the methods disclosed herein may have a goal of meeting a signal quality metric that enables application throughput requirements (if any) to be satisfied.

In accordance with some embodiments, a second method (sometimes referred to herein as Method B) may use the reduction on data rate to determine a maximum application throughput. In some embodiments, the maximum application throughput may be used as a maximum number of clients (e.g., per cell). In that regard, in some embodiments, one or more of the methods disclosed herein may take the maximum number of clients (e.g., per cell) into consideration in determining an access point configuration.

In some embodiments, it may be desirable to take the maximum number of client information into consideration for demanding applications such as, for example, Voice over IP or PROFINET since the maximum number of client information represents an upper limit on the number of client devices that can be reliably supported. In accordance with some embodiments, the maximum number of client information may be used to determine whether client density information (or maximum number of clients per wireless cell) is satisfied by an access point configuration, such as for example, an access point configuration determined in accordance with one or more of the methods described herein.

In some embodiments, RF data may be supplied to a mathematical admission control model, which in response at least thereto, may provide information indicative of the reduced throughput (which may be referred to as available bandwidth). The input to the admission control model may be a list containing the location and configuration information of access points and the application profile including but not limited to client type, application type and application throughput requirements. The output from the admission control model may be a maximum load that can be sustained by an access point.

In accordance with some embodiments, the maximum load may be used to determine a reduction in throughput by comparing the maximum load with the theoretical maximum throughput for Method A. In accordance with some other embodiments, the maximum load may be used to determine a maximum number of clients which can be supported by each access point for Method B.

To that effect, in some embodiments, a delay inference method may be used to calculate a mean channel access delay of each client. In some such embodiments, the mean channel access delay may be calculated in accordance with a mathematic model of the 802.11 contention avoidance mechanism, including the random access and exponential back-off behaviors. In some embodiments, the mean channel access delay may represent an estimate of a mean channel access time of target uplink traffic from a client with the measured mean transmission time and inter-arrival time of the target traffic and the remaining aggregated traffic, respectively.

Further in that regard, in some embodiments, an estimate of the mean, channel access time may be determined using a modification of the 801.11 channel access model described in G. Bianchi, “Performance Analysis of the IEEE 802.11 Distributed Coordination Function”, IEEE Journal of Selected Areas in Communication, 18(3), March 2000. However, in some other embodiments, other methods and/or mathematical models may be used to determine an estimate of the mean channel access time.

In some embodiments, the method may include determining parameters c₁ and c₂ as follows:

$${c}_{1} = \frac{1 + {aCW}_{min}}{2}$$

$${c}_{2} = {log}_{2} ( \frac{1 + {aCW}_{max}}{1 + {aCW}_{min}} )$$

where aCWₘᵢₙ is a minimum Contention Window size, and
aCWₘₐₓ is a maximum Contention Window size.

In some embodiments, the minimum contention Window size, aCWₘᵢₙ, and the maximum Contention Window size, aCWₘₐₓ, may be determined in accordance with 802.11 (see ANSI/IEEE Std 802.11a-1999, “IEEE Standard for Wireless LAN Medium Access Control (MAC) and Physical Layer (PHY) Specifications: High-speed Physical Layer in the 5 Ghz Band”, 2002; and ANSI/IEEE Std 802.11-1999 “IEEE Standard for Wireless LAN Medium Access Control (MAC) and Physical Layer (PHY)”, 1999).

A traffic load of a remaining traffic loadₑₗₛₑ (total traffic excluding the target traffic of concern) may be determined as a ratio as follows:
loadₑₗₛₑ=sum TxTimeₑₗₛₑ/sampleInterval
where sumTxTimeₑₗₛₑ, is a measured sum of frame transmission time, and
sampleInterval is an interval between a current sample and a previous sample.

In addition, a parameter a may be determined as follows:

$$α = \frac{1}{2 ( 1 - {load}_{else} )} + \frac{1 - {( 2 {load}_{else} )}^{1 + {c}_{2}}}{2 ( 1 - 2 {load}_{else} ) ( 1 - {load}_{else} )}$$

Using the parameters determined above, a mean back-off time that a client experiences during contentions be determined based on a Markov model (as described in A. Veres, et.al., “Supporting Service Differentiation in Wireless Frame Networks Using Distributed Control”, IEEE Journal of Selected Areas in Commun, 19(10), October 2001). of the exponential back-off mechanism of the 802.11 MAC. In that regard, the mean back-off time that a client experiences during contentions for channel access may be determined as follows:

$$\overline{backoffTime} = α {c}_{1} aSlotTime \frac{1}{1 - {load}_{else}} + \overline{{txTime}_{else}} \frac{1 + {load}_{else}}{2 ( 1 - {load}_{else} )}$$

where t̅x̅T̅i̅m̅e̅ₑ̅ₗ̅ₛ̅ₑ̅ is the measured mean frame transmission time for the remaining traffic, and
aSlotTime represents a minimum time slot (in micro-second) as defined in the 802.11 standard (see ANSI/IEEE Std 802.11a-1999, “IEEE Standard for Wireless LAN Medium Access Control (MAC) and Physical Layer (PHY) Specifications: High-speed Physical Layer in the 5 Ghz Band”, 2002; and ANSI/IEEE Std 802.11-1999 “IEEE Standard for Wireless LAN Medium Access Control (MAC) and Physical Layer (PHY)”, 1999).

An estimate of the mean channel access time may be determined based on the mean back-off time, b̅a̅c̅k̅o̅f̅f̅T̅i̅m̅e̅, and a mean frame transmission time of the target traffic, ( t̅x̅T̅i̅m̅e̅_̅{̅s̅e̅l̅f̅}̅):
a̅c̅c̅e̅s̅s̅T̅i̅m̅e̅= t̅x̅T̅i̅m̅e̅_̅{̅s̅e̅l̅f̅}̅+loadₑₗₛₑ b̅a̅c̅k̅o̅f̅f̅T̅i̅m̅e̅

In some embodiments, the mean channel access time and the application throughput requirements may be used to determine a maximum number of clients that can be supported by each access point.

Assuming uniform load for all cells where n is the total number of interfering cells
load_{self}= l̅o̅a̅d̅_̅{̅a̅v̅g̅}̅; loadₑₗₛₑ=(n−1) l̅o̅a̅d̅_̅{̅a̅v̅g̅}̅ the average channel occupation time C̅h̅O̅c̅c̅T̅i̅m̅e̅ is calculated from the mode (802.11a/b/g), data rate (Mb/s) and the average packet size for the application.

A load per cell may then be calculated by solving the following nonlinear equation:

$$\overline{{load}_{avg}} = \frac{1}{1 + ( n - 1 ) \overline{{load}_{avg}} ( \frac{\overline{backoffTime}}{\overline{ChOccTime}} )} .$$

Given the load per cell, the total available bandwidth and client application throughput requirements; a maximum number of clients that can be supported by each cell may then be calculated as follows:
MaximnumNumbersOfClients=LoadPerCell/ApplicationThroughtputRequirement
where LoadPerCell in expressed in terms of Mbps; and
ApplicationThroughtputRequirement is expressed in terms of Mbps and is rounded to the nearest integer value toward zero

In some embodiments, one or more of the methods described herein to determine an estimate of a characteristic of a network or a portion thereof may be employed in the process set forth in FIG. 2, the process set forth in FIG. 8, the process set forth in FIG. 10 and/or in any other process and/or apparatus set forth herein. In that regard, in some embodiments, revising and/or optimizing an access point configuration may include revising and/or optimizing until the application throughput requirements for the given number of client devices are satisfied or no solution is found. In some such embodiments, revising and/or optimizing an access point configuration may include adding one or more access points (e.g., one at a time) and/or changing the configuration (e.g., adjusting the settings) of one or more access points (e.g., to improve and/or optimize the performance of the access point configuration) until a signal quality level reaches a point where a specified number of client devices can be accommodated in accordance with the application throughput requirements (if any).

In some embodiments, one or more of the parameters and/or values described above may be expressed in units other than those used above. For example, the estimate of the throughput may be expressed in units other than Mbps. Moreover, in some embodiments, one or more of the parameters and/or values determined above may be determined using one or more methods that are different than the methods described above.

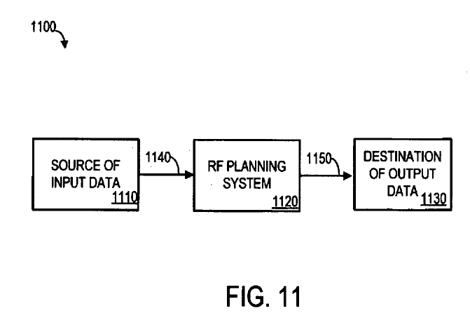

FIG. 11 is a block diagram of a system 1100, according to some embodiments. Referring to FIG. 11, the system 1100 includes a source of input data 1100, an RF planning system 1120 and destination of output data 1130. The source of input data 1110 may be coupled to the RF planning system 1120 through a communication link 1140. The RF planning system 1120 may be an RF planning system in accordance with one or more embodiments described herein. In some embodiments, the RF planning system may be used to perform one or more of the processes described herein. The RF planning system 1120 may be coupled to the destination of output data 1130 through a communication link 1150. In some embodiments, the source of input data 110 includes one or more input devices. In some embodiments, the destination of output data 1130 includes one or more output devices.

In operation, the source of input data 1110 may supply information to the RF planning system 1120 through the communication link 1140. The RF planning system 1120 may receive the information provided by the source of input data 1110 and may store information and/or provide information to the destination of output data 1130, e.g., which may include a display device, through the communication link 1150.

In some embodiments, the source of input data 1110 provides data for a region of interest or portion thereof, e.g., data for each of the buildings 102, 104, 106 of the campus 100. The data may be generated in any suitable manner. In some embodiments, the data includes data that may have been gathered building-by-building in accordance with conventional practices and on the basis of the individual building coordinate systems for each building. In some embodiments, the data includes data representing the location and composition of walls and/or other features within the region of interest and/or portion thereof.

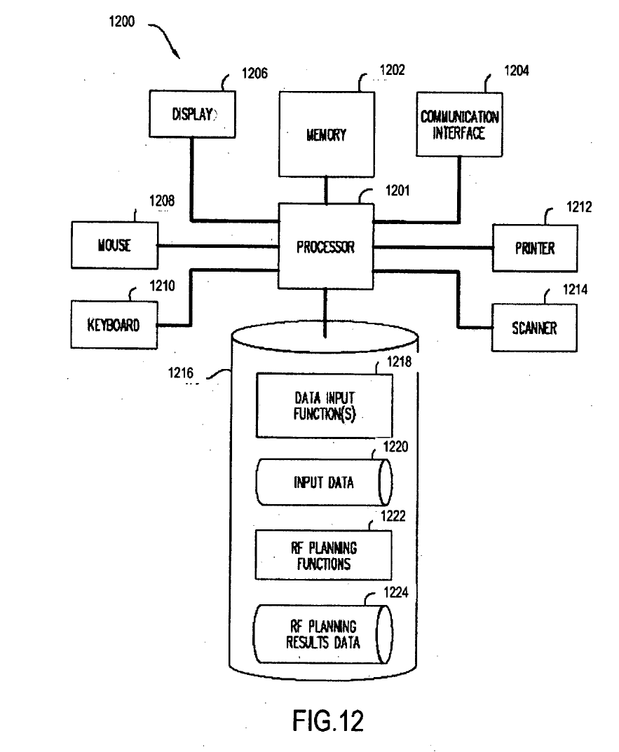

FIG. 12 is a block diagram of the RF planning system 1120 (FIG. 11) in accordance with some embodiments. Referring to FIG. 12, in some embodiments, an RF planning system may include a computer 1200 that may, for example, implement one, some or all of the RF planning functions described herein. The computer 1200 may, in some embodiments, be entirely conventional in terms of its hardware aspects. For example, the computer 1200 may, in its hardware aspects and some of its software, be a conventional personal computer. As indicated in this paragraph and discussed further below, software may be provided to control the computer 1200 in accordance with one or more of the embodiments disclosed herein, and data may be stored and manipulated in the computer 1200 in accordance with one or more of the embodiments disclosed herein The computer 1200 may include one or more processors 1201, which may be a conventional microprocessor or microprocessors. Also included in computer 1200 is memory 1202 that is in communication with the processor 1201. The memory 1202 may be, in some embodiments, one or more of RAM, ROM, flash memory, etc., and may serve as one or more of working memory, program storage memory, etc.

Notwithstanding the above, as used herein, a processor may be any type of processor. For example, a processor may be programmable or non programmable, general purpose or special purpose, dedicated or non dedicated, distributed or non distributed, shared or not shared, and/or any combination thereof. If the processor has two or mote distributed portions, the two or more portions may communicate with one another through a communication link. A processor may include, for example, but is not limited to, hardware, software, firmware, hardwired circuits and/or any combination thereof.

As used herein, a communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

In some embodiments, the computer 1200 may also include a communication interface 1204. The communication interface 1204 may, for example, allow the computer 1200 to access information via a data network. In addition or alternatively, some or all of the data required for the processes described below may be provided to the computer 1200 via one or more storage media such as floppy disks, CD-ROMs, etc., or via direct input from a user. Media drives for such media may be included in the computer 1200 but are not separately shown.

As seen from the drawing, the computer 1200 may also include a number of different input/output devices 1206, including, for example, a display screen, a conventional pointing device such as a mouse, trackball, touchpad, etc., a computer keyboard, and a printer.

Also included in the computer 1200, and in communication with the processor 1201, is a mass storage device 1216. Mass storage device 1216 may be constituted by one or more magnetic storage devices, such as hard disks, one or more optical storage devices, and/or solid state storage. The mass storage 1216 may store software 1218 which controls the computer 1200 to receive input regarding attributes, and the intended operating environment of, a proposed wireless data network The data may be stored in one or more data storage structures 1220 maintained in the mass storage 1216. The mass storage 1216 may also store software 1222 to perform RF planning functions utilizing the data stored at 1220. In addition, other software, which is not represented in the drawing, may be stored in the mass storage 1216, including operating system software and/or other applications that allow the computer 1200 to perform other functions in addition to RF planning and the inputting of data used in RF planning. Still further, the mass storage 1216 may store one or more data storage structures 1224 to store the data which results from operation of the RF planning software. In practice the functions described herein may all be performed in one computer or may be divided among two or more computers that may be in communication with each other and/or may exchange data via removable memory devices such as floppy disks, CD-ROMs, etc. It will be appreciated that all of the software referred to above may be temporarily stored in memory 1202 and fetched instruction-by-instruction by the processor 1201 to program the processor 1201. The software may also be referred to as “program instructions” or “computer readable program code”.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

As used herein, the phrase “a portion of a region of interest” may include, but is not limited to, one or more regions of a region of interest. A region of interest may or may not be a continuous region of interest a region. For example, some regions of interests may be a single continuous region of interest or may include two or more separate regions. If the region of interest is a single continuous region of interest, such region of interest may nonetheless have one or more portions (e.g., any number of portions). Moreover, if a region of interest includes more than one portion, there may or may not be one or more demarcations between the portions.

Moreover, unless stated, otherwise, the term “coupled to” means “connected directly to and/or connected indirectly to”. In addition, unless stated otherwise, as used herein, terms such as, for example, “supply to” mean “supply directly to and/or supply indirectly to”.

The several embodiments described herein are solely for the purpose of illustration. Other variations both in form and/or detail can be made thereupon by those skilled in the art without departing from the spirit and scope of the invention, which is defined by the appended claims.

What is claimed is:

1. A method comprising:
receiving, in a processing system, data defining a region of interest; and
determining, in the processing system, an access point configuration that provides radio frequency coverage of the region of interest and satisfies minimum desired bandwidth criteria for the region of interest.

2. The method of claim 1 wherein determining an access point configuration that provides radio frequency coverage of the region of interest and satisfies minimum desired bandwidth criteria for the region of interest comprises:
determining an access point configuration that provides radio frequency coverage of the region of interest and satisfies minimum desired bandwidth criteria for the region of interest using a minimum number of access points.

3. The method of claim 1 wherein determining an access point configuration that provides radio frequency coverage of the region of interest and satisfies minimum desired bandwidth criteria for the region of interest comprises:
(a) determining an access point configuration that provides radio frequency coverage of the region of interest
(b) determining a characterization of the access point configuration;
(c) determining a modified access point configuration by at least one change to the access point configuration;
(d) determining a characterization of the modified access point configuration;
(e) revising the access point configuration if the characterization of the modified access point configuration satisfies a criteria; and
(f) repeating (c)-(e) until a termination criteria is satisfied.

4. The method of claim 3 wherein revising the access point configuration if the characterization of the modified access point configuration satisfies a criteria comprises:
using the modified access point configuration as a new access point configuration if the characterization of the modified access point configuration satisfies a criteria.

5. The method of claim 3 wherein the access point configuration defines a location for each of a plurality of access points and wherein determining a modified access point configuration comprises:
changing a location defined for an access point of the plurality of access points.

6. The method of claim 3 wherein determining a modified access point configuration comprises determining a modified access point configuration by a single change to the access point configuration.

7. The method of claim 3 wherein determining a characterization of the access point configuration comprises determining a cost function of the access point configuration and wherein determining a characterization of the modified access point configuration comprises determining a cost function of the modified access point configuration.

8. The method of claim 7 wherein revising the access point configuration if the characterization of the modified access point configuration satisfies a criteria comprises:
using the modified access point configuration as a new access point configuration if the cost function of the modified access point configuration is less than the cost function of the access point configuration.

9. The method of claim 7 wherein determining a cost function of the access point configuration comprises determining a cost function of the access point configuration based at least in part on (i) a number of access points in the access point configuration and (ii) a quality of coverage provided by the access point configuration.

10. The method of claim 1 wherein determining an access point configuration that provides radio frequency coverage of the region of interest and satisfies minimum desired bandwidth criteria for the region of interest comprises:
determining an estimate of a throughput provided by the access point configuration.

11. The method of claim 10 wherein determining an estimate of a throughput provided by the access point configuration comprises at least one of the following:
(a) determining an equivalent SINR and determining an estimate of a throughput provided by the access point configuration based at least in part on the equivalent SINR; and
(b) determining an estimate of a mean channel access delay and determining an .estimate of a throughput provided by the access point configuration based at least in part on the estimate of the mean channel access delay.

12. An article comprising:
a storage medium having stored thereon instructions that if executed by a machine, result in the following:
receiving, in a processing system, data defining a region of interest; and
determining an access point configuration that provides radio frequency coverage of the region of interest and satisfies minimum desired bandwidth criteria for the region of interest.

13. The article of claim 12 wherein determining an access point configuration that provides radio frequency coverage of the region of interest and satisfies minimum desired bandwidth criteria for the region of interest comprises:
determining an access point configuration that provides radio frequency coverage of the region of interest and satisfies minimum desired bandwidth criteria for the region of interest using a minimum number of access points.

14. The article of claim 12 wherein determining an access point configuration that provides radio frequency coverage of the region of interest and satisfies mininum desired bandwidth criteria for the region of interest comprises:
(a) determining an access point configuration that provides radio frequency coverage of the region of interest
(b) determining a characterization of the access point configuration;
(c) determining a modified access point configuration by at least one change to the access point configuration;
(d) determining a characterization of the modified access point configuration;
(e) revising the access point configuration if the characterization of the modified access point configuration satisfies a criteria; and
(1) repeating (c)-(e) until a termination criteria is satisfied.

15. The article of claim 14 wherein revising the access point configuration if the characterization of the modified access point configuration satisfies a criteria comprises:
using the modified access point configuration as a new access point configuration if the characterization of the modified access point configuration satisfies a criteria.

16. The article of claim 14 wherein determining a modified access point configuration comprises determining a modified access point configuration by a single change to the access point configuration.

17. The article of claim 14 wherein determining a characterization of the access point configuration comprises determining a cost function of the access point configuration and wherein determining a characterization of the modified access point configuration comprises determining a cost function of the modified access point configuration.

18. The article of claim 17 wherein revising the access point configuration if the characterization of the modified access point configuration satisfies a criteria comprises:
using the modified access point configuration as a new access point configuration if the cost function of the modified access point configuration is less than the cost function of the access point configuration.

19. The article of claim 17 wherein determining a cost function of the access point configuration comprises determining a cost function of the access point configuration based at least in part on (i) a number of access points in the access point configuration and (ii) a quality of coverage provided by the access point configuration.

20. The article of claim 12 wherein determining an access point configuration that provides radio frequency coverage of the region of interest and satisfies minimum desired bandwidth criteria for the region of interest comprises:
determining an estimate of a throughput provided by the access point configuration.

21. The article of claim 20 wherein determining an estimate of a throughput provided by the access point configuration comprises at least one of the following:
(a) determining an equivalent SINR and determining an estimate of a throughput provided by the access point configuration based at least in part on the equivalent SINR; and
(b) determining an estimate of a mean channel access delay and determining an estimate of a throughput provided by the access point configuration based at least in part on the estimate of the mean channel access delay.

22. Apparatus comprising:
a processor to receive data defining a region of interest and determine an access point configuration that provides radio frequency coverage of the region of interest and satisfies minimum desired bandwidth criteria for the region of interest.

23. The apparatus of claim 22 wherein the processor comprises a processor to (a) determine an access point configuration that provides radio frequency coverage of the region of interest, (b) determine a characterization of the access point configuration, (c) determine a modified access point configuration by at least one change to the access point configuration, (d) determine a characterization of the modified access point configuration, (e) revise the access point configuration if the characterization of the modified access point configuration satisfies a criteria; and (f) repeat (c)-(e) until a termination criteria is satisfied.

24. The apparatus of claim 22 wherein the access point configuration defines a location for each of a plurality of access points and wherein the processor comprises:
a processor to change a location defined for an access point of the plurality of access points.

25. The apparatus of claim 23 wherein the processor comprises a processor to determine a modified access point configuration by a single change to the access point configuration.

26. The apparatus of claim 23 wherein the processor comprises a processor to determine a cost function of the access point configuration and a cost function of the modified access point configuration.

27. The apparatus of claim 26 wherein the processor comprises a processor to use the modified access point configuration as a new access point configuration if the cost function of the modified access point configuration is less than the cost function of the access point configuration.

28. The apparatus of claim 23 wherein the processor comprises a processor to use the modified access point configuration as a new access point configuration if the characterization of the modified access point configuration satisfies a criteria.

29. The apparatus of claim 22 wherein the processor comprises:
a processor to determine an estimate of a throughput provided by the access point configuration.

30. The apparatus of claim 29 wherein the processor comprises at least one of the following:
(a) a processor to determine an equivalent SINR and determine the estimate of the throughput provided by the access point configuration based at least in part on the equivalent SINR; and
(b) a processor to determine an estimate of a mean channel access delay and determine the estimate of the throughput provided by the access point configuration based at least in part on the estimate of the mean channel access delay.
